(19) United States
(12) Patent Application Publication
(10) Pub. No.: US 2006/0278085 A1
(43) Pub. Date: Dec. 14, 2006

(54) Dehumidifier

(75) Inventors: Moon Shin Kim, Changwon-si (KR); Seok Hun Kim, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/450,414

(22) Filed: Jun. 12, 2006

(30) Foreign Application Priority Data
Jun. 13, 2005 (KR) P2005-0050277
Jun. 13, 2005 (KR) P2005-0050278

(51) Int. Cl. F25D 17/06; B01D 53/02

(52) U.S. Cl. 96/140; 96/141; 62/94

(57) ABSTRACT

The present invention relates to a dehumidifier for improving dehumidifying efficiency and easy draining of dehumidified water to an outside of the dehumidifier. The dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, and a filter assembly detachably mounted to the case for cleaning air drawn through the inlet.

### TECHNICAL FIELD

The present invention relates to dehumidifiers, and more particularly, to a dehumidifier, in which moisture is adsorbed, not by refrigerant, but by desiccant to collect the moisture separately, for improving dehumidifying efficiency.

### BACKGROUND ART

In general, the dehumidifier reduces humidity of a room by drawing humid air from the room, making the humid air to pass through a heat exchanger having a condenser and an evaporator through which refrigerant flows to remove moisture from the air, and discharging the air having the moisture removed therefrom, again.

That is, the dehumidifier takes heat from air around it by vaporizing liquid refrigerant at the evaporator. In more detail, a temperature of the evaporator drops as the refrigerant vaporizes, and as the air passes through the evaporator, a temperature of the air also drops.

As the temperature around the evaporator drops, the moisture in the air condenses, to form dew on a surface of the evaporator.

FIG. 1 illustrates a diagram of a related art dehumidifier.

Referring to FIG. 1, the related art dehumidifier is provided with a cabinet 1 having an inlet (not shown) for drawing room air, a filter 2 mounted on an inlet side, a heat exchanger 3 in front of the filter 2 on the cabinet 1 for heat exchange with the room air to dehumidify the room air, a fan assembly 4 in front of the heat exchanger 3 for forced circulation of the room air, a water tank 6 under the heat exchanger for collecting condensed water, and a front panel 5, a frontal exterior of the dehumidifier, having an outlet 5a.

However, the related art dehumidifier has the following problems.

The outlet 5a in the front panel 5 provides a poor outer appearance, and is difficult to change a direction of discharge of the air.

Since it is required to disassemble the case wholly or partly for replacing the filter, the related art dehumidifier has a problem in that replacement of the filter is not convenient.

Because the room air passed through the heat exchanger 3 is discharged to the room again directly even if the moisture is not removed from the air fully, the dehumidifying efficiency is poor.

Moreover, the use of the compressor in the related art humidifier for circulation of the refrigerant leads a production cost high, and causes much noise and vibration during operation.

### DISCLOSURE

[Technical Problem]

Accordingly, the present invention is directed to a dehumidifier that substantially obviates one or more problems due to limitations and disadvantages of the related art.

An object of the present invention is to provide a dehumidifier which has a high dehumidifying efficiency, low cost, and very low noise and vibration.

Another object of the present invention is to provide a dehumidifier which has a good looking exterior, and enables easy notice of the water level of the water held in the water tank.

[Technical Solution]

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, and a filter assembly detachably mounted to the case for cleaning air drawn through the inlet.

[Advantageous Effects]

Thus, the dehumidifier of the present invention has the following advantages.

The absorption of moisture from room air and continuous dry of the absorbed moisture by a separate regenerator assembly improves dehumidifying efficiency compared to the related art dehumidifier.

The elimination of a compressor from the related art dehumidifier permits to reduce weight of the dehumidifier, as well as noise of the dehumidifier, to improve convenience of use of the dehumidifier.

Along with this, the water level of the water tank in the case made visible from an outside of the dehumidifier improves convenience of use.

### DESCRIPTION OF DRAWINGS

The accompanying drawings, which are included to provide a further understanding of the invention, illustrate embodiment(s) of the invention and together with the description serve to explain the principle of the invention. In the drawings;

FIG. 1 illustrates an exploded perspective view of a related art dehumidifier;

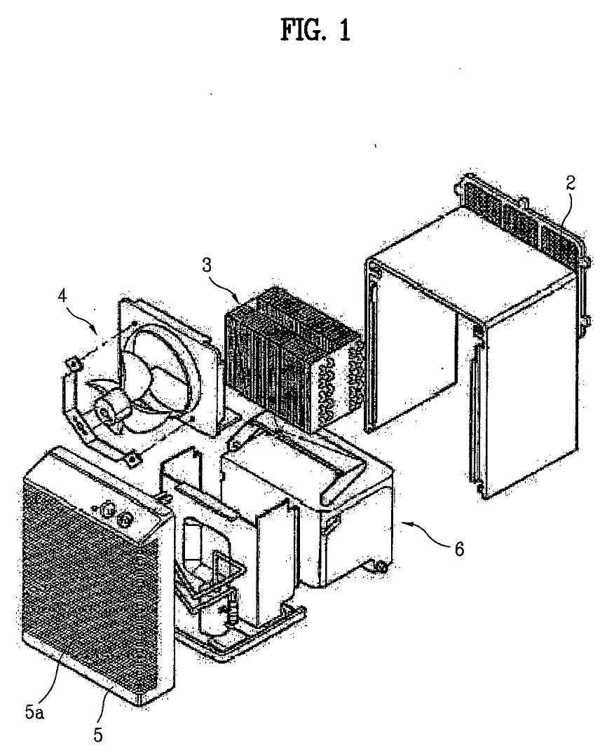

FIG. 2 illustrates a perspective view of a dehumidifier in accordance with a preferred embodiment of the present invention;

FIG. 3 illustrates a perspective view of the dehumidifier in FIG. 2 with a filter assembly separated therefrom;

FIG. 4 illustrates a perspective view of the dehumidifier in FIG. 2 having a water tank separated therefrom;

FIG. 5 illustrates a perspective view of the dehumidifier in FIG. 2 seen in another direction;

FIG. 6 illustrates an exploded detailed perspective view of the dehumidifier in FIG. 2;

FIG. 7 illustrates an exploded perspective view of the dehumidifier in FIG. 2 for explaining a dehumidifying process;

FIG. 8 illustrates a perspective view of a dehumidifier in accordance with another preferred embodiment of the present invention;

FIG. 9 illustrates a perspective view of the dehumidifier in FIG. 8 seen from a rear thereof;

FIG. 10 illustrates an exploded perspective view of the dehumidifier in FIG. 8 with a front panel opened;

FIG. 11 illustrates an exploded perspective view of the dehumidifier in FIG. 8;

FIG. 12 illustrates a perspective view of a dehumidifier in accordance with another preferred embodiment of the present invention;

FIG. 13 illustrates a perspective view of the dehumidifier in FIG. 12 seen from a rear thereof;

FIG. 14 illustrates the dehumidifier in FIG. 12 having a water tank separated therefrom;

FIG. 15 illustrates a perspective view of the dehumidifier in FIG. 12 having a rear panel separated therefrom; and

FIG. 16 illustrates an exploded perspective view of the dehumidifier in FIG. 12.

### BEST MODE

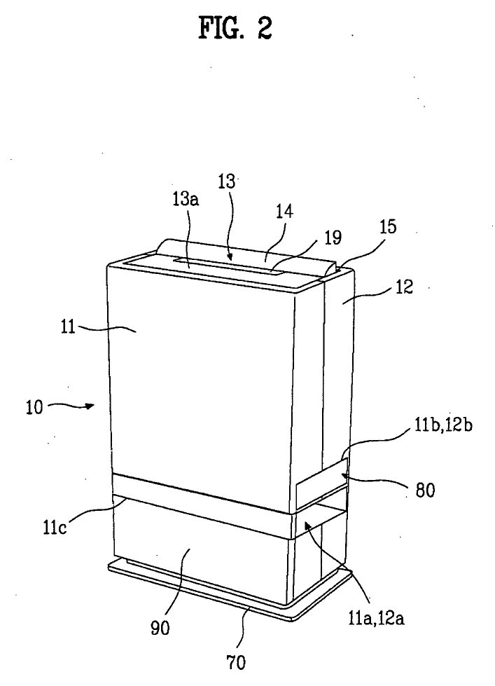

Reference will now be made in detail to the preferred embodiments of the present invention, examples of which are illustrated in the accompanying drawings FIGS. 2 to 7. Wherever possible, the same reference numbers will be used throughout the drawings to refer to the same or like parts.

Referring to FIGS. 2 to 7, the dehumidifier includes a case 10 of an exterior of the dehumidifier, a heat exchanger 20 of a heat conductive material in the case 10, a desiccant assembly 30 in the case 10 for absorbing moisture from the air, a blower assembly 40 for forcing the room air to be drawn into the case 10, and a regenerator assembly 50 for forced circulation of a portion of the room air drawn into the case 10 through the heat exchanger 20.

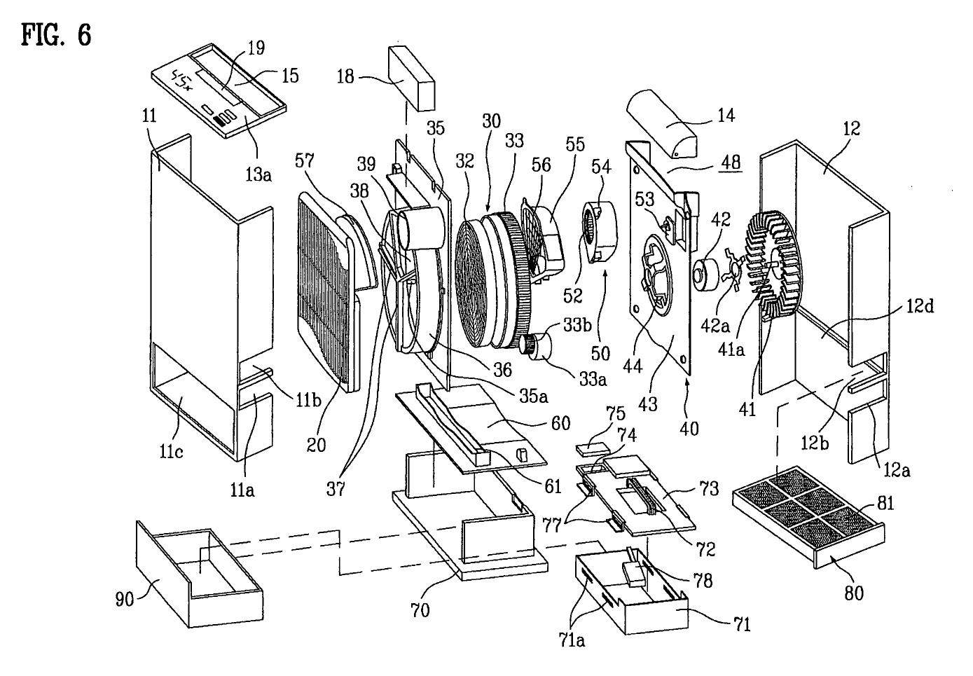

The case 10 includes a front frame 11 of a front, and opposite front sides of the case 10, a rear frame 12 of a rear, and opposite rear sides of the case 1, and a top panel 13 of a top side of the case 10. Under the case 10, there is a base pan 70 (see FIG. 6) of a bottom of the case 10.

Opened in opposite sides of a lower side of each of the front frame 11 and the rear frame 12, there are substantially rectangular inlets 11a, or 12a for drawing room air.

Opened in opposite sides of the front frame 11 and the front frame 12, there are filter openings 11b and 12b for placing in, and taking out the filter assembly 80. The filter openings 11b and 12b are right over the inlets 11a, and 12b.

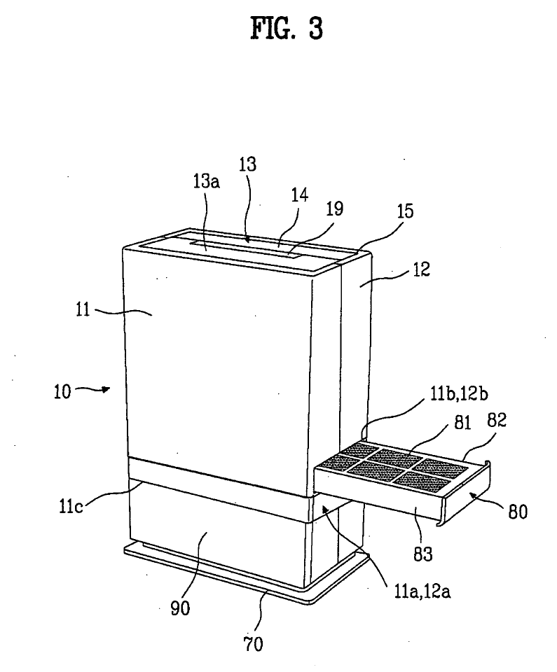

Referring to FIG. 3, the filter assembly 80, used for cleaning room air drawn through the inlets 11a, and 12a, is slidably pushed in/pulled out of the case 10 at one side thereof horizontally in mounting/dismounting the filter assembly 80. The filter assembly 80 includes a filter 81 for filtering foreign matters from air, a filter case 82 for seating, and holding the filter 81, and a filter guide 83 for seating and supporting the filter case 82, and sliding along the filter openings 11b and 12b.

There is a guide rib 12d projected inwardly from inside surfaces of the front frame 11 and the rear frame 12 for slidably supporting the filter guide 83. Accordingly, if the user holds one end of the filter assembly 80, and makes the filter assembly 80 to slide through the filter openings 11b and 12b, the filter guide 83 moves smoothly along the guide rib 12d, to move in/out of the case 10.

The filter 81 may include a single unit selected from a prefilter for filtering relatively large sized dust from the air drawn through the inlets 11a, and 12a, deodoring filters for removing smell, dust collecting filters each for collecting dust by an electrical action, and a HEPA filter for removing fine dust, or an assembly having above various filters combined as one unit.

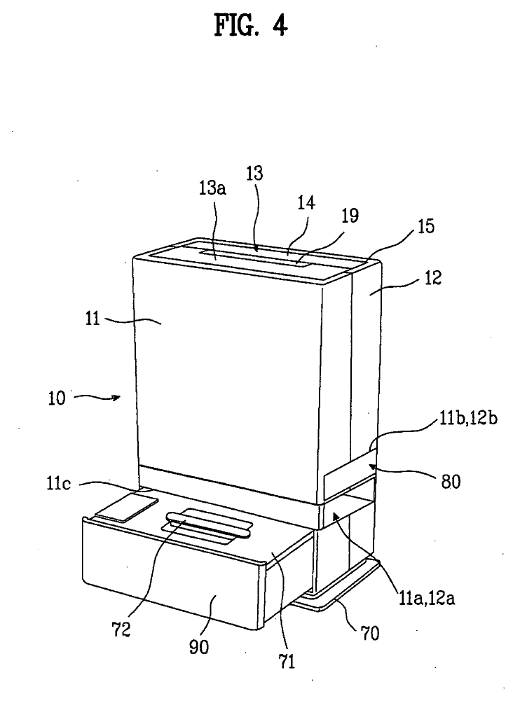

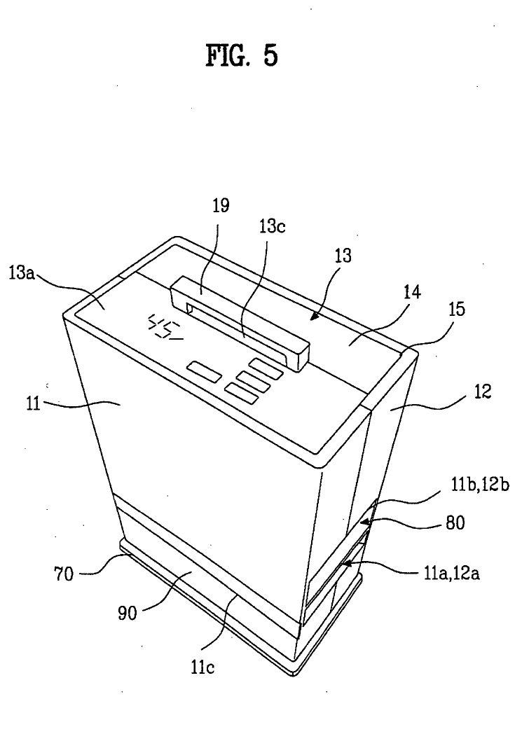

Referring to FIGS. 4 and 5, at a lower side of the front frame 11, there is a water tank opening 11c for pushing in/pulling out the water tank 71 which holds water dehumidified at the dehumidifier. The water tank opening 11c is under the inlets 11a, and 12a.

The top panel 13 which is a top side of the case 10 is substantially rectangular, and has a display unit 13a mounted on a front for displaying an operation state of the dehumidifier, an outlet 15 at a rear for discharging air dehumidified at the dehumidifier to the room.

Accordingly, the dehumidifier of the present invention draws air through opposite side of the case 10, has moisture removed from the air therein, and discharges through a top side of the case 10.

Though not shown, the display unit 13a has a plurality of operation buttons for operating the dehumidifier, and there is a dehumidifier handle 19 between the display unit 13a and the outlet 15 for easy movement of the dehumidifier.

Though not shown, the dehumidifier handle 19 may be of one touch type in which the dehumidifier handle 19 is moved up/down from the top panel 13 with a spring and touch means at opposite ends thereof by one time of pressing. The dehumidifier handle 19 is placed in a dehumidifier handle groove 13c in the top panel 13.

At the outlet 15, there is a discharge louver 14 for controlling an air discharge direction from the outlet 15. Though not shown, the discharge louver 14 is mounted rotatable around a front end of the outlet 15 in an up/down direction by separate driving means.

Therefore, when the dehumidifier is not in operation, the discharge louver 14 moves to a lower side of the outlet 15 to close the outlet 15, and when the dehumidifier is in operation, the discharge louver 14 moves to an upper side of the outlet 15 to open the outlet 15.

In the meantime, referring to FIG. 6, beneath the top cover 13, there is a control box 18 electrically connected to the display unit 13a, the operation buttons, and so on for controlling operation of the dehumidifier. Though not shown, there are a plurality of components, such as circuit boards, for overall control of the operation of the dehumidifier.

On a front side of the inside of the case 10, there is a heat exchanger 20 for making heat exchange with the room air drawn through the inlets 11a and 12a. The heat exchanger 20 has two tiers of different sized heat exchangers having a plurality of metal tubes arranged at regular intervals in communication with one another for letting the air blown by the regenerator assembly 50 to be introduced thereto, flow therein, and be discharged therefrom. The heat exchanger 20 has a drain hole (not shown) at a bottom for discharging condensed water from the heat exchanger 20.

In rear of the heat exchanger 20, there is a regenerating cover 57 in correspondence to the heater case 55 to be described later. The regenerating cover 57 has an air pass opening (not shown) in a lower surface in communication with an inside of the heat exchanger 20 for guiding the air circulated by the regenerator assembly 50 to the heat exchanger 20.

In rear of the regenerating cover 57, there is a desiccant assembly 30 for absorbing moisture from the room air drawn through the inlet 11a. The desiccant assembly 30 includes a desiccant member 32 for absorbing moisture from air, a rotor 33 rotatably mounted for housing the desiccant member 32, a rotor housing 35 for rotatably supporting the rotor 33, and a motor 33a for providing rotating power to rotate the rotor 33.

The desiccant member 32 has a disk shape constructed of paper, with a plurality of pass through holes like a honeycomb. In more detail, the desiccant member 32 is fabricated by rolling two layers of paper like a honeycomb and bonded together, to form a plurality of the pass through holes, and permeating a desiccant solution therein.

According to this, when the room air passes through the pass through holes in the desiccant member 32, the moisture is absorbed in the desiccant member, to dry the air.

The desiccant member 32 has a disk shape and mounted to the rotor 33. The rotor 33 is a circular frame, and has a gear on an outside circumference. On an outer side of the rotor 33, there is a rotor driving gear 33b rotated by the rotor motor 33a. The rotor driving gear 33b is engaged with the outside circumference of the rotor 33, to rotate the rotor 33.

The rotor motor 33a rotates the rotor 33 slowly (for an example, 1 RPM) so that the desiccant member 32 absorbs moisture from the air passing therethrough.

The rotor 33 is housed in, and supported on the rotor housing 35. The rotor housing 35 has a square plate shape substantially, with an opened center. Around the opened center of the rotor housing 35, the rotor cover 36 is formed as a circular rim projected therefrom. In the rotor cover 36, the rotor 33 is housed.

At a center of the rotor cover 36, there is a rotation shaft 35a which is a rotation center of the rotor 33 supported by a plurality of supporting arms 37 extended from an edge of the rotor cover 36 to the center in a radial direction.

At an upper side of a right side of the rotor housing 35, there is a circulating duct 39 for guiding the air from the heat exchanger 20 to the regenerator assembly 50, and at a lower side of the right side of the rotor housing 35, there is the motor 33a coupled with the rotor driving gear 33b as one unit for providing rotating power to rotate the rotor 33.

In rear of the desiccant assembly 30, as a component of the regenerator assembly 50 to be described later, there is a heater 56 for providing heat to dry the desiccant member 32. The heater 56 has a fan shape substantially, and is encased in a heater case 55 having a front and a portion of a top opened.

Accordingly, since the heater case 55 is mounted matched to a fan shaped regenerative flow passage 38 partitioned at an upper side of the rotor housing 35 by the rotor arms 37, the heater case 55 serves to regenerate a portion of the desiccant member 32 to dry the portion, continuously.

In rear of the heater 56, there is the blower assembly 40 for drawing the room air through the inlet 12a, forcibly. The blower assembly 40 includes a fan 41 for drawing the room air through the inlet 12a, a blower housing 43 for housing, and supporting the fan 41, and a fan motor 42 for providing rotation power to the fan 41.

The blower housing 43 has a square plate shape substantially, with a circular opening at a center, to form a flow passage of the room air drawn by the rotation power of the fan 41. At a top of the blower housing 43, there is a discharge flow passage 48 for discharging the room air drawn by the fan 41 to an outside of the dehumidifier.

At the opened portion of the blower housing 43, there is a motor support 44 for housing a portion of the fan motor 42, and supporting the fan motor 42. Opposite to the motor support 44, there is a motor mount 42a for securing the fan motor 42.

In front of an upper side of the blower assembly 40, there is the regenerator assembly 50 for passing a portion of the room air drawn through the inlet 12a through the case 10.

The regenerator assembly 50 includes a regenerating fan 52, a regenerating fan housing 54 for housing and supporting the regenerating fan 52, a regenerating motor 53 for providing a rotating power to rotate the regenerating fan 52, a heater 56 for providing heat to dry the desiccant member 32, and a heater case 55 for casing the heater 56. The regenerating fan 52 may be a centrifugal type fan, such as a sirocco fan, but a variety of types of fans may be used.

The regenerating fan housing 54 has a disk shape substantially for mounting the regenerating fan 52 therein. The regenerating fan housing 54 has a suction opening at a center in communication with the circulating duct 39, and an outlet at one side of underside in communication with the heater case 55.

Therefore, when the regenerating fan 52 rotates, the air is drawn forcibly into the regenerating fan housing 54 through the circulating duct 39, and discharged to the heater case 55.

That is, the regenerating fan housing 54 guides the air from the regenerating fan 52 to the heater 56 and the regenerating flow passage 38, to keep drying a portion of the desiccant member 32 rotating at a position opposite thereto.

In the meantime, there is a drain pan 60 under the heat exchanger 20 for collecting condensed water from the heat exchanger 20 and guiding to a water tank 71. The drain pan 60 is rectangular substantially, with a drain groove projected upward for guiding condensed water from the heat exchanger 20 to the water tank 71.

Under the drain pan 60, there is a base pan 70 which is a bottom of the case 10 for fixedly coupling the front frame 11 and the rear frame 12. The base pan 70 has a box shape with opened one side opposite to front frame 11, and has a drawer 90 mounted therein so as to be pushed in, and pulled out of the base pan 70 for receiving the water tank 71 therein.

It is preferable that the drawer 90 has a box shape with an opened top, and a front surface flush with the front frame 11.

The water tank 71 has a hexahedral box shape having an opened top. On top of the water tank 71, there is a water tank cover 73 detachably mounted thereon for opening/closing the opened top of the water tank 71. On opposite sides of the water tank cover 73, there are a plurality of water tank cover fasteners 77 for hooking with fastening projections 71a at upper sides of opposite sides of the water tank 71, respectively.

It is preferable that there is a water tank handle 76 at a center of a top of the water tank cover 73 for easy handling of the water tank 71. On one side of the water tank handle 76, there is a water tank inlet 74 in communication with a bottom of the drain groove 61 for guiding the water to the water tank 71.

On the water tank inlet 71, there is an inlet cover 75 for preventing water from flowing out of the water tank 71 at the time the water tank 71 in in/out.

It is preferable that there is a float 78 (not shown) in the water tank 71 for moving up/down along with a water level changing water introduced thereto. The float is connected to a sensor so that a full water level is noticed from an outside of the case through the display unit 13a.

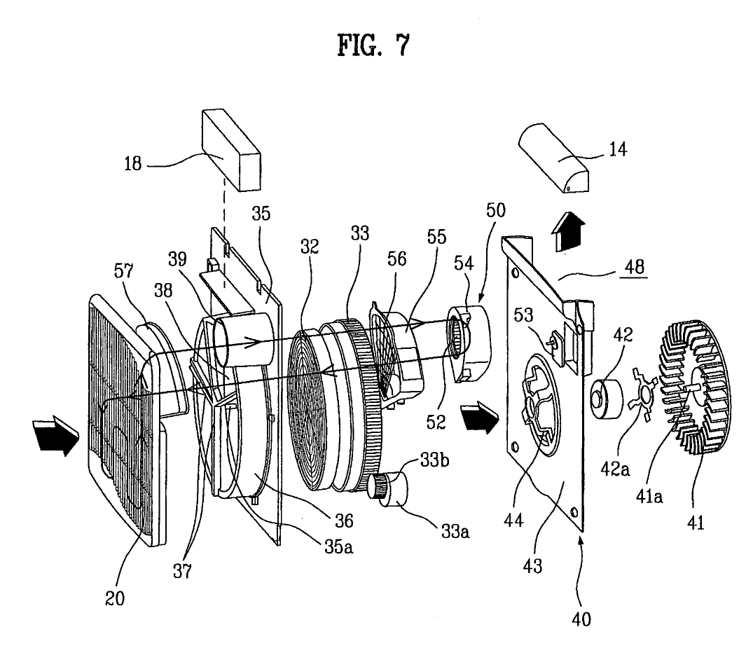

The operation of the dehumidifier of the present invention will be described in detail with reference to FIG. 7.

As indicated with large arrows, when humid room air is drawn into the case 10 through the inlet 12a (see FIG. 2) by the rotating power of the fan 41, the air has foreign matters removed therefrom as the air passes through the filter 80 (see FIG. 3), and passes through the desiccant assembly 30 via the heat exchanger 20.

In this instance, the air has moisture removed therefrom as the air passes through the pass through holes in the desiccant member 32, and is discharged to the discharge flow passage 48 through the fan 41 of the blower assembly 40. Then, the air discharged to the discharge flow passage 48 is discharged to the room through the discharge louver 14.

Next, as indicated with small arrows, in a regenerating process for drying the desiccant member 32 of the desiccant assembly 30 continuously, the air blown forcibly by the rotation of the regenerating fan 52 passes through the heater 60 through the heater case 55, and is heated to warm air such that the warm air evaporates moisture absorbed in the desiccant member 32.

The high temperature, humid air passed through the desiccant member 32 moves toward the heat exchanger 20 through the regenerating flow passage 38, and introduced into the regenerating cover 57. Then, the high temperature, humid air circulates through an inside of the heat exchanger 20, and has moisture therein condensed as the high temperature, humid air heat exchanges with the room air having a relatively low temperature drawn through the inlets 11a, and 12a in the circulating process. The condensed water is drained to the drain groove 61 of the drain pan 60 through the drain hole (not shown) at the bottom of the heat exchanger, and held in the water tank 71.

In the meantime, the air passed through the heat exchanger 20 and having moisture therein removed therefrom repeats circulation in which the air is guided to the regenerating flow passage 38 through the rotor housing 35 and the circulating duct 39 again by the regenerating fan 52, to repeat the regenerating process of drying the desiccant member 32, continuously.

Thus, the dehumidifier of the present invention removes moisture from the room air by means of two streams of air flow. That is, the room air drawn by the fan 41 passes through, and has moisture therein absorbed at, the desiccant member 32, and is discharged to an outside of the dehumidifier through the outlet 15.

At the same time with this, while the dehumidifier makes the high temperature air to flow through the regenerative flow passage 38 by the regenerating fan 52, the dehumidifier separates the moisture from a portion of the desiccant member again and blows toward the heat exchanger 20, to condense, and remove the moisture from the air, at the heat exchanger 20, and circulates the air by the regenerating fan 52.

If the water tank 71 is filled with water fully through above dehumidifying process, for the float (not shown) to sense the full water level, the full water level is informed to the user through the display unit 13a on the top cover 13. Then, as shown in FIG. 4, the user pulls out the drawer 90 through the water tank opening 11c, holds the handle 72 on the water tank 71, pulls out the water tank 71 from the drawer 90, and empties the water.

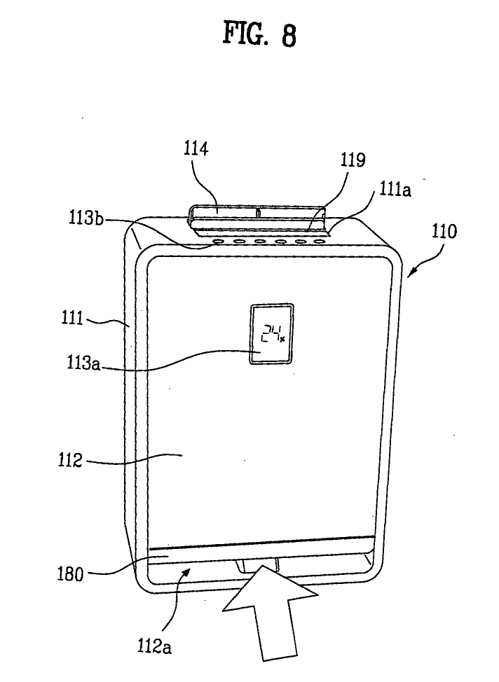

Next, a dehumidifier in accordance with another preferred embodiment of the present invention will be described with reference to FIGS. 8 to 11. Parts identical to the parts of the foregoing embodiment will be given the same reference numerals, and detailed description of which will be omitted.

The dehumidifier of the second embodiment includes a case 110, a heat exchanger 20, a desiccant assembly 30, a blower assembly 40, and a regenerator assembly 50. The heat exchanger 20, the desiccant assembly 30, the blower assembly 40, and the regenerator assembly 50 are identical to the foregoing embodiment, of which detailed description will be omitted.

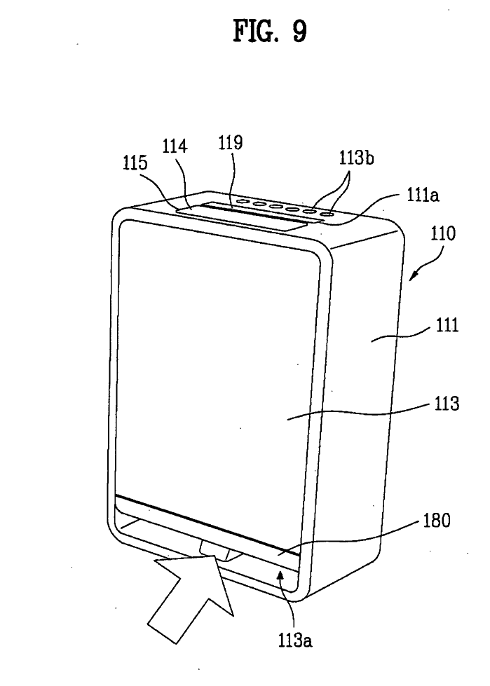

Referring to FIGS. 8 and 9, the case 110 includes a box shaped case body 111 with opened front and rear, a front panel 112 mounted to open/close the front of the case body 111, and a rear panel 113 mounted to close a rear of the case body 111.

The front panel 112 is coupled to the case body 111 at a left side with hinges (not shown) so as to open/close the front of the case body 111 as the front panel 112 rotates in a lateral direction.

The front panel 112 and the rear panel 113 have heights lower than the opened front and rear of the case body 111. Therefore, at lower sides of the front panel 112 and the rear panel 113, there are a front inlet 112a and a rear inlet 113a in communication with an inside of the case body 111.

Though the embodiment shows the rear panel 113 fixedly secured to the case body 111, different from this, the rear panel 113 may also be rotatably hinged to one side edge of the case 110 alike the front panel 112.

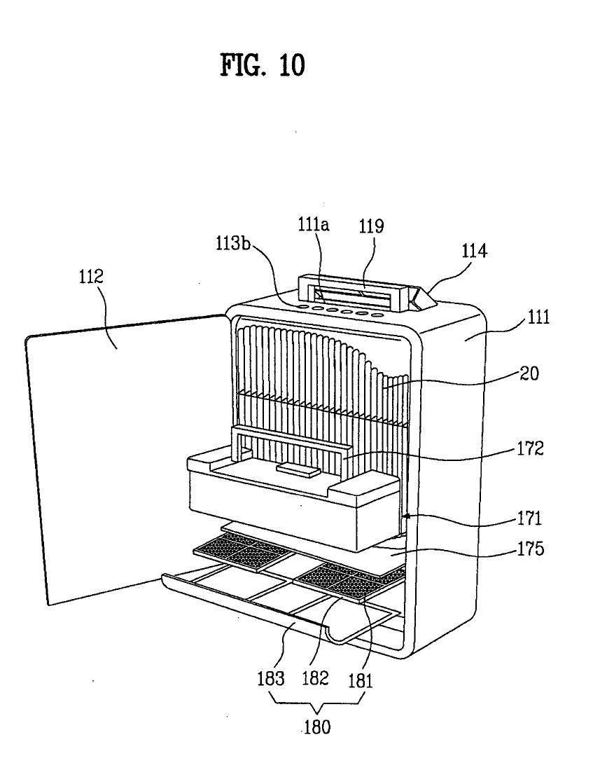

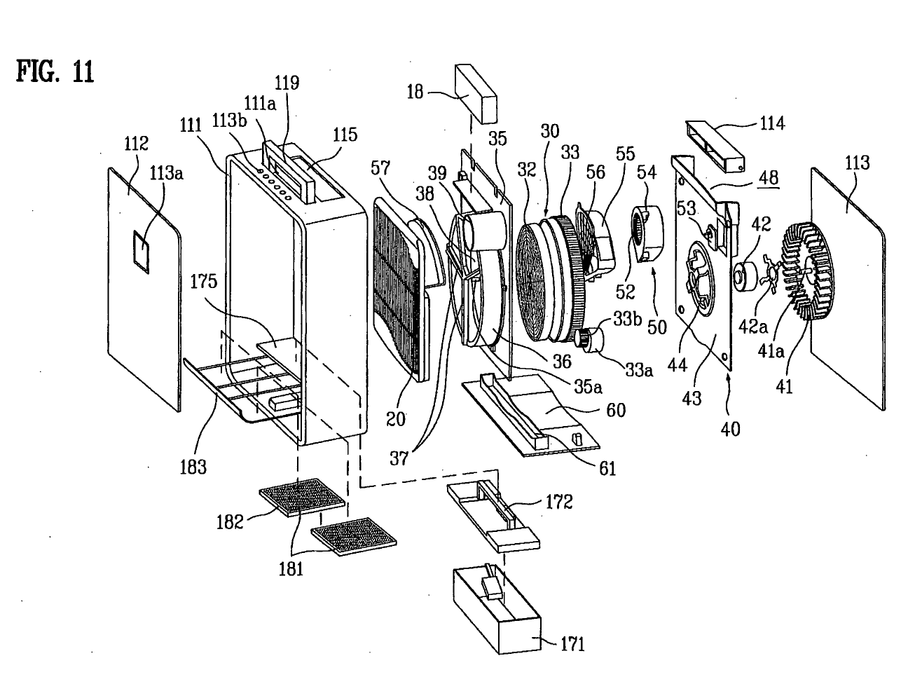

Referring to FIGS. 10 and 11, there is a filter assembly 180 detachably mounted under the case body 111, for cleaning room air drawn through the front inlet 112a and the rear inlet 113a.

The filter assembly 180 is slidably pushed in, and pulled out of the case body 111 through the front thereof. The filter assembly 180 includes a filter 181 for filtering foreign matters from air, a filter case 182 for seating, and holding the filter 181, and a filter guide 183 for seating and supporting the filter case 182, and sliding through the front of the case 110. The filter guide 183 has a width and a depth in conformity with a width and a depth of the case body 111. Though not shown, the filter guide 183 is seated on a guide rib in the case body 111, to slide along the guide rib.

By opening the front panel 112, and pulling or pushing a front end of the filter guide 183 forward or backward of the case body 111, the filter assembly 180 can be dismounted/mounted from/to the case body 111, easily.

The filter 181 may include a single unit selected from a prefilter for filtering relatively large sized dust from the air drawn through the front inlets 112a, and the rear inlet 13a, deodoring filters for removing smell, dust collecting filters each for collecting dust by an electrical action, and an HEPA filter for removing fine dust, or an assembly having above various filters combined as one unit.

Placed over the filter assembly 180, there is a water tank 171 for holding water dehumidified in the case body 111. The water tank 171 is seated on a water tank support 175 of a substantially rectangular plate shape on an inside of the case body 111. The water tank support 175 may be fixedly secured to the inside of the case body 111, or may be mounted slidably in a front or a rear direction.

In a case the water tank support 175 is slidable, the user may push, or pull the water tank 171 in/out of the case body 111 by sliding the water tank support 175.

In the meantime, on an upper side of the front of the front panel 112, there is a display window 113a for displaying an operation state of the dehumidifier. The display window 113a is substantially transparent or semi-transparent, for displaying functional icons indicating the present humidity of the room, and the operation state of the dehumidifier.

On a top of the case body 111, there are a plurality of operation buttons 113b for the user to operate the dehumidifier from an outside of the dehumidifier, and in rear of the operation buttons 113b, there is a dehumidifier handle 119 for easy movement of the dehumidifier.

Alike the dehumidifier handle in the foregoing embodiment, the dehumidifier handle 119 may be of one touch type in which the dehumidifier handle 119 is moved up/down from the top of the case 110 with a spring and touch means at opposite ends thereof by one time of pressing. The dehumidifier handle 119 is placed in a dehumidifier handle groove 111a in the top of the case body 111.

On a rear side of the case body 111, there is an outlet 115 for guiding air dehumidified in the dehumidifier thus to be discharged to the room again. The outlet 115 has a discharge louver 114 for controlling a direction of discharge of the air. Though not shown, the discharge louver 114 is mounted to be rotatable in an up/down direction around a shaft at a rear end by separate driving means.

Therefore, when the dehumidifier is not in operation, the discharge louver 114 moves to a lower side of the outlet 115 to close the outlet 115, and when the dehumidifier is in operation, the discharge louver 114 moves to an upper side of the outlet 115 to open the outlet 115, to control the direction of air discharged from the outlet 115.

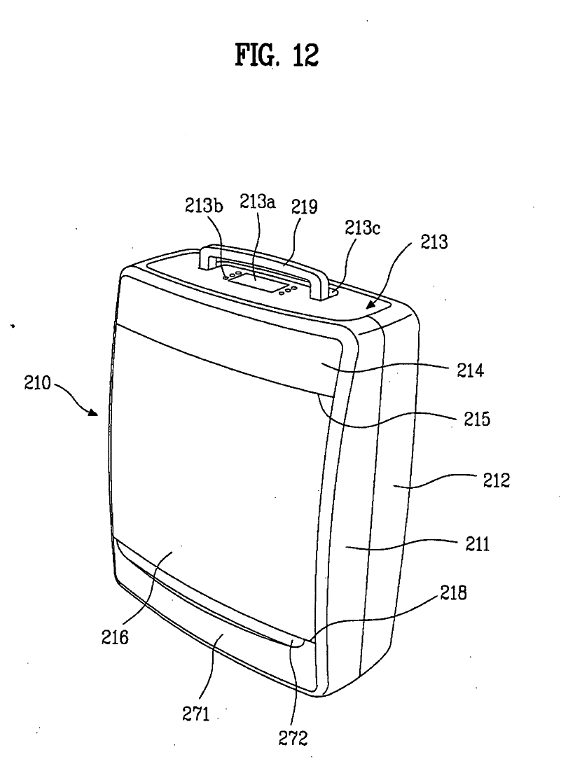

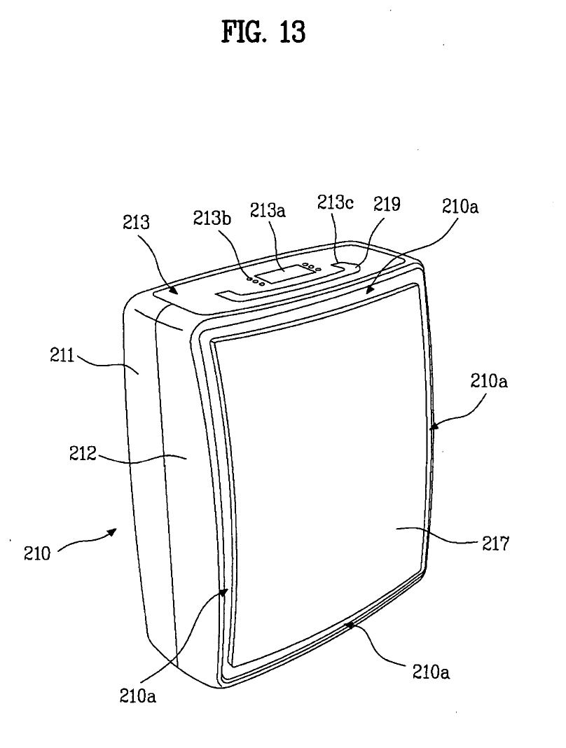

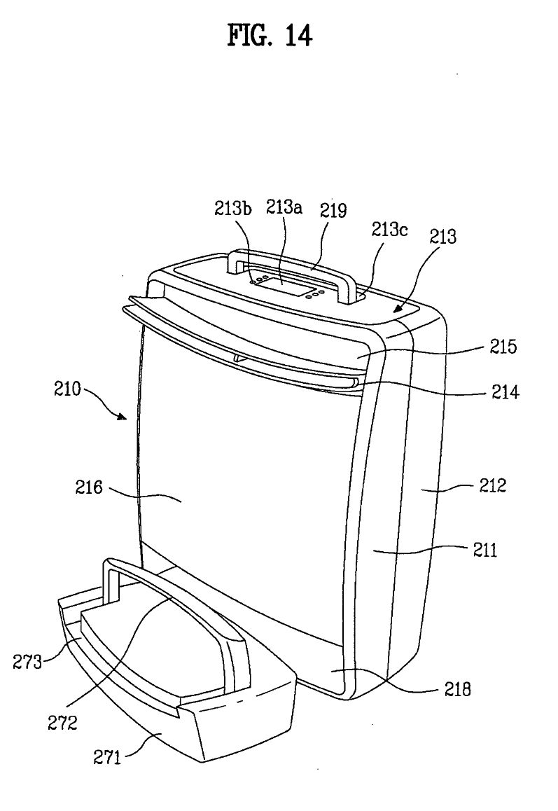

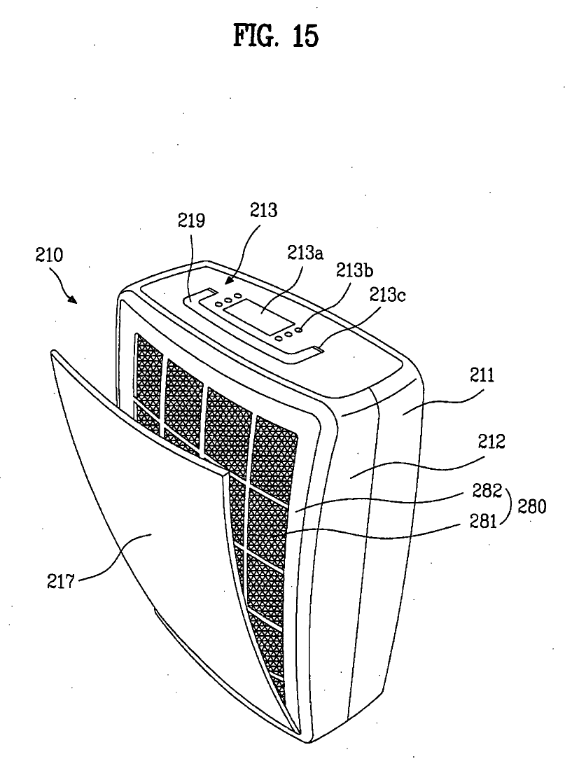

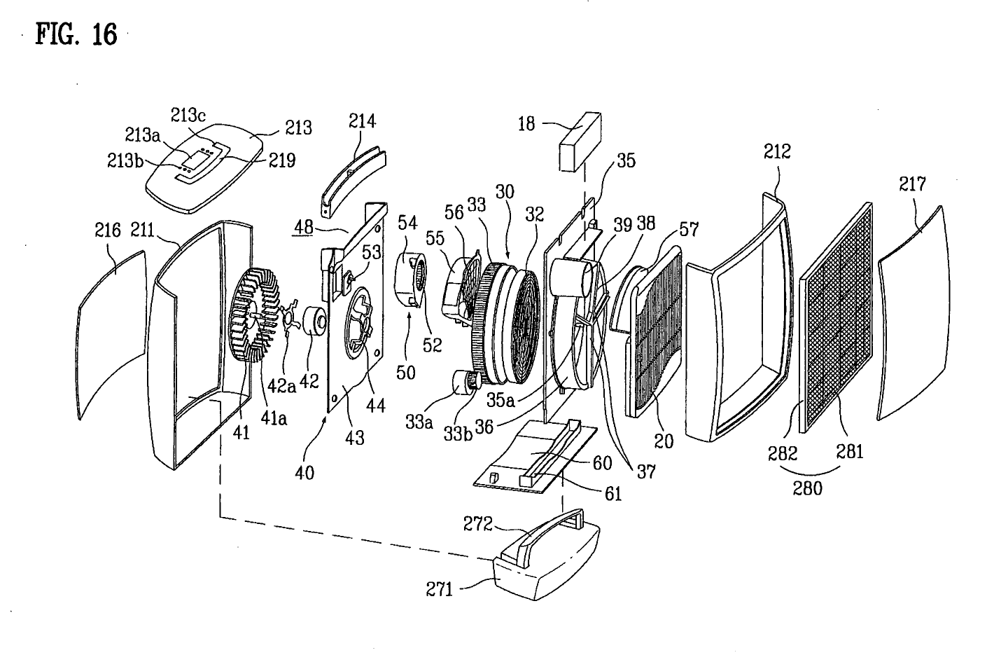

Another preferred embodiment of the present invention will be described with reference to FIGS. 12 to 16.

Except a portion of the case 210, the dehumidifier of the embodiment has units provided in the case 210 for dehumidifying, i.e., the heat exchanger 20, the desiccant assembly 30, the blower assembly 40, and the regenerator assembly 50, identical to the foregoing embodiment.

The dehumidifier of the embodiment has a case 210 having a substantially hexahedral box shape, separable in a front half and a rear half. That is, the case 210 includes a front frame 211 of exteriors of a front rim, sides, and a bottom of a front half of the case 210, and a rear frame 212 of exteriors of a rear rim, sides, and a bottom of a rear half of the case 210. On tops of the front frame 211 and the rear frame 212, there is a top panel 213 of a top exterior of the case 210.

The front frame 211 has an opened front, and the rear frame 212 has an opened rear. A front panel 216, and a rear panel 217 are mounted to the opened front of the front frame 211 and the opened rear or the rear frame 212, respectively. The front panel 216 and the rear panel 217 are convex rectangular plates, to provide a sense of volume to the case 210 on the whole to improve a sense of beauty.

The rear panel 217 is coupled to the rear frame 212 such that edges of the rear panel 2217 are spaced from the rear frame 212 by predetermined distances to form a gap. The gap between the rear panel 217 and the rear frame 212 forms an inlet 210a for drawing room air into the case 210. Accordingly, when the dehumidifier is put into operation, the room air is drawn into the case 210 from up/down, and left/right sides of case 210 through the inlet 210a formed along the rim of the rear panel 217.

The front panel 216 has a height lower than the front frame 211, to form spaces between a top side edge of the front panel 216 and a top side edge of an opening of the front frame 211, and a bottom side edge of the front panel 216 and a bottom side edge of the opening of the front frame 211.

The space between the top side edge of the front panel 216 and the top side edge of an opening of the front frame 211 is an outlet 215 for discharging dehumidified air. There is a discharge louver 214 at the outlet 215.

The discharge louver 214 has a plurality of louvers fabricated as one unit, with opposite ends hinged (not shown) at opposite sides of the front frame 211, to enable the discharge louver 214 rotatable in a front/rear direction.

Though the discharge louver 214 may be designed to rotate by separate driving means such as a step motor, the discharge louver 214 may be designed to have a heavier lower side than a top side with reference to the hinge so that the discharge louver 214 rotates in the front/rear direction by an air pressure being discharging through the outlet 215.

Accordingly, when the dehumidifier is not in operation, the discharge louver 214 rotates in a rear direction, to close the outlet 215, and when the dehumidifier is in operation, the discharge louver 214 rotates in a front direction by the pressure of air being discharged, to open the outlet 215, thereby controlling a direction of the dehumidified air discharged through the outlet 215.

The space between the bottom edge of the front panel 216 and the bottom edge of the opening of the front frame 211 is a water tank opening 218 for pushing in, pulling out the water tank 271 therethrough.

The water tank 271 has a handle 272 rotatably mounted thereon. In a top surface of a front side of the water tank 271, there is a handle groove 273 for placing the handle therein 272. Therefore, once the handle 272 is placed in the handle groove 273, the handle 272 is exposed to an outside. It is preferable that a top surface of the handle 272 is flush with the front panel 216, substantially.

In the meantime, the top panel 213 is rectangular substantially, and has a display unit 213a mounted at a center for displaying an operation state of the dehumidifier.

On right and left sides of the display unit 213a, there are a plurality of operation buttons 213b for operating the dehumidifier. On a rear side of the display unit 213a, there is a dehumidifier handle 219 for easy movement of the dehumidifier. The dehumidifier handle 219 is placed in a dehumidifier handle groove 213c of a substantially c shape in the top panel 213.

The rear panel 217 is coupled to the rear frame 212 with hinges (not shown) at a bottom of the rear frame 212 so as to be rotatable in an up/down direction.

Detachably mounted on the opening of the rear frame 212, there is a filter assembly 280 for cleaning room air drawn through the inlet 210a.

The filter assembly 280 has a shape in conformity with a shape of the opening of the rear frame 212, and includes a filter case 282 detachably secured to the rear frame 212, and a filter 281 cased in the filter case 282.

The filter 281, used for filtering foreign matters from the air, may include a single unit selected from a prefilter for filtering relatively large sized dust from the air drawn through the inlet 210a, deodoring filters for removing smell, dust collecting filters each for collecting dust by an electrical action, and a HEPA filter for removing fine dust, or an assembly having above various filters combined as one unit.

When it is intended to replace the filter assembly 280, the user may rotate the rear panel 217 downward to open the filter assembly 280, separate the filter case 282 of the filter assembly 280 from the rear frame 212, and mount a new filter assembly 280 on the rear frame 212.

Since a dehumidifying process is the same with the foregoing dehumidifier, detailed description of the process will be omitted.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A dehumidifier comprising:
a case;
an inlet passed through the case for introduction of air from an outside of the case to an inside of the case;
an outlet formed to pass through a top of the case for discharging air dehumidified in the case to the outside of the case;
a desiccant assembly for absorbing moisture from air drawn into the case;
a blower assembly for drawing air through the inlets and blowing the air to the outlet;
a regenerator assembly for blowing hot air to the desiccant assembly for drying the desiccant assembly;
a heat exchanger for condensing high temperature, humid air blown by the regenerator assembly through the desiccant assembly, to separate the moisture from the air; and
a filter assembly detachably mounted to the case for cleaning air drawn through the inlet.

2. The dehumidifier as claimed in claim 1, wherein the filter assembly includes;
a filter for filtering foreign matters from air, and
a filter supporting portion detachably secured to a place in the vicinity of the inlet in the case for supporting the filter.

3. The dehumidifier as claimed in claim 2, wherein the filter supporting portion includes;
a filter case for holding the filter, and
a filter guide having the filter case separably seated thereon, for slidably mounting/dismounting to/from the case.

4. The dehumidifier as claimed in claim 1, wherein the inlet is in a lower side of the case, and the filter assembly is slidably mounted/dismounted to/from a place right over the inlet.

5. The dehumidifier as claimed in claim 1, wherein the case has an opening in one side, and a plate shaped panel is mounted spaced a predetermined distance from the one side of the case, to form the inlet between the panel and the one side of the case.

6. The dehumidifier as claimed in claim 1, further comprising a water tank mounted in the case so as to be pushed, or pulled in/out of the case through a lower side of the case, for receiving and holding water condensed at the heat exchanger.

7. The dehumidifier as claimed in claim 6, further comprising a box shaped drawer mounted in a lower side of the case so as to be slidable into/from the case, having an opened top and a space for receiving the water tank.

8. The dehumidifier as claimed in claim 6, further comprising a water tank support mounted inside of the case for seating and supporting the water tank.

9. The dehumidifier as claimed in claim 8, wherein the water tank support is mounted so as to be slidable into/from the case.

10. The dehumidifier as claimed in claim 1, wherein the case includes a handle on a top.

11. The dehumidifier as claimed in claim 1, wherein the desiccant assembly includes;
a desiccant member for absorbing moisture from air,
a desiccant rotor rotatably mounted for housing the desiccant member,
a desiccant rotor housing for rotatably supporting the desiccant rotor, and
a rotating unit for rotating the desiccant rotor.

12. The dehumidifier as claimed in claim 11, wherein the rotating unit includes;
a gear formed along an outside circumference of the desiccant rotor,
a rotor driving gear engaged with the gear, and
a rotor motor for providing a rotating power to rotate the rotor driving gear.

13. The dehumidifier as claimed in claim 1, wherein the blower assembly includes;
a fan for generating a suction power for drawing air,
a blower housing for housing and supporting the fan, and
a fan motor mounted on the blower housing for rotating the fan.

14. The dehumidifier as claimed in claim 1, wherein the regenerator assembly includes;
a regenerating fan for blowing air toward the desiccant assembly,
a regenerating fan housing for housing the regenerating fan,
a regenerating motor for providing a rotating power to rotate the regenerating fan,
a heater for heating the air blown by the regenerating fan,
a heater case for casing the heater, having one side in communication with the regenerating fan housing, and the other side in communication with a portion of the desiccant assembly for guiding air from the regenerating fan to the desiccant assembly,
a regenerating cover for guiding the air passed through the desiccant assembly by the regenerating fan to an inside of the heat exchanger, and
a circulating duct for guiding the air passed through the heat exchanger to the regenerating fan.

15. The dehumidifier as claimed in claim 1, further comprising a front panel coupled to the case at a front thereof.

16. The dehumidifier as claimed in claim 1, further comprising a rear panel coupled to the case at a rear thereof.

17. The dehumidifier as claimed in claim 1, wherein the case includes;
a box shaped front frame having an opened rear, and
a box shaped rear frame coupled to the rear of the front frame.

18. The dehumidifier as claimed in claim 1, wherein the case at a top has a display unit for displaying an operation state of the dehumidifier, and operation buttons for applying an operation order to the dehumidifier.

19. The dehumidifier as claimed in claim 1, wherein the case includes a display window on a front for displaying an operation state of the dehumidifier.

20. The dehumidifier as claimed in claim 1, further comprising a discharge louver movably mounted to one side of the outlet for opening/closing the outlet.
